(19) United States
(12) Patent Application Publication
(10) Pub. No.: US 2009/0078828 A1
(43) Pub. Date: Mar. 26, 2009

(54) ANTI-ICE VALVE COMPONENTS AND METHODS OF COUPLING A VALVE ASSEMBLY TO A SERVO CONTROLLER OF ANTI-ICE VALVE COMPONENTS

(75) Inventors: Maureen Sugai, Phoenix, AZ (US); Don J. Atkins, Chandler, AZ (US); William H. Reed, Gilbert, AZ (US); Joel E. LaBenz, Chandler, AZ (US); Steve L. Patterson, Chandler, AZ (US); Dan E. Hitzler, Chandler, AZ (US)

Correspondence Address: HONEYWELL INTERNATIONAL INC., 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 11/860,808

(22) Filed: Sep. 25, 2007

(51) Int. Cl. B64D 15/02; B23K 31/02; B23P 19/04

(52) U.S. Cl. 244/134 B; 228/208; 29/592

(57) ABSTRACT

Anti-ice valve components are provided that include a servo housing, a valve body, and a transfer tube. The servo housing includes a surface having a cavity formed therein. The valve body is spaced apart from the servo housing and includes a surface having a cavity formed therein. The transfer tube has a first end, a second end, and a length, where the first end is disposed in the servo housing cavity, the second end is disposed in the valve body cavity, and the length extends between the first end and the second end and has a portion forming a bend of at least 180 degrees.

### TECHNICAL FIELD

The inventive subject matter generally relates to anti-ice valve components, and more particularly relates to coupling servo controllers and valve assemblies of the anti-ice valve components.

### BACKGROUND

A gas turbine engine may be used to power various types of vehicles and systems. A particular type of gas turbine engine that may be used to power aircraft is a turbofan gas turbine engine. A turbofan gas turbine engine may include, for example, a fan section, a compressor section, a combustor section, a turbine section, and an exhaust section. The fan section induces air from the surrounding environment into the engine and accelerates a fraction of the air toward the compressor section. The remaining fraction of air is accelerated into and through a bypass plenum, and out the exhaust section. The compressor section, which may include a high pressure compressor and a low pressure compressor, raises the pressure of the air it receives from the fan section to a relatively high level.

A portion of the compressed air then enters the combustor section, where a ring of fuel nozzles injects a steady stream of fuel into a plenum. The injected fuel is ignited to produce high-energy compressed air. The air then flows into and through the turbine section causing turbine blades therein to rotate and generate energy. The air exiting the turbine section is exhausted from the engine via the exhaust section, and the energy remaining in the exhaust air aids the thrust generated by the air flowing through the bypass plenum.

Another portion of the compressed air may be directed from the compressor into a bleed port. The bleed port may be used to bleed the air to other components, such as to an anti-ice valve component, which may operate by using the bleed air. Anti-ice valve components are used to de-ice aircraft surfaces, such as aircraft wings, and typically include at least a valve body and a valve element. A flowpath for the bleed air extends through the valve body, and the valve element is disposed in the flowpath. The valve element may be coupled to a pneumatic servo controller that regulates the pressure of the bleed air through the flowpath. In this regard, the pneumatic servo controller receives a portion of the bleed air from one or more tubes that communicate with the flowpath. Conventionally, the tubes are straight tubes that extend from an opening in the valve body to an opening in a servo housing encasing the pneumatic servo controller. Each opening in the valve body is threaded and includes a bushing disposed therein. A first end of each tube, which is also threaded, is inserted through the bushing and is screwed into the valve body opening to form a leak-tight fit therewith. A second end of each tube is disposed in a corresponding opening of the servo housing and is sealed therein by a sealing ring.

Although the aforementioned anti-ice valve components operate sufficiently in existing engines, they may be improved. In particular, because the bleed air from the compressor may be relatively high in temperature (e.g., greater than 538° C. (approximately 1000° F.)), certain parts of the anti-ice valve component should be capable of withstanding such high temperatures without deleterious effects.

Accordingly, it is desirable to have an anti-ice valve component that may have a relatively long service life, even when repeatedly exposed to high temperatures. In addition, it is desirable for the anti-ice valve component to remain relatively lightweight and to have a similar or smaller footprint than existing anti-ice valve components. Furthermore, other desirable features and characteristics of the inventive subject matter will become apparent from the subsequent detailed description of the inventive subject matter and the appended claims, taken in conjunction with the accompanying drawings and this background of the inventive subject matter.

### BRIEF SUMMARY

Anti-ice valve components and methods of coupling a valve assembly to a servo controller are provided.

In an embodiment, by way of example only, the anti-ice valve component includes a servo housing, a valve body, and a transfer tube. The servo housing includes a surface having a cavity formed therein. The valve body is spaced apart from the servo housing and includes a surface having a cavity formed therein. The transfer tube has a first end, a second end, and a length. The first end is disposed in the servo housing cavity, the second end is disposed in the valve body cavity, and the length extends between the first end and the second end and having a portion forming a bend of at least 180 degrees.

In another embodiment, by way of example only, a servo housing, a valve housing, a transfer tube, a first ring-shaped adapter, and a second ring-shaped adapter. The servo housing comprises a first material and includes a surface having a cavity formed therein. The valve housing is spaced apart from the servo housing and comprises a second material that is different than the first material. The valve housing includes a surface having a cavity formed therein. The transfer tube has a first end, a second end, and a length. The first end is disposed in the servo housing cavity, the second end is disposed in the valve body cavity, and the length extends between the first end and the second end and having a portion forming a bend of at least 180 degrees. The first ring-shaped adapter is disposed in the servo housing cavity wherein the first end of the transfer tube is disposed in the first ring-shaped adapter. The second ring-shaped adapter is disposed in the valve body cavity, wherein the second end of the transfer tube is disposed in the second-ring-shaped adapter.

In still another embodiment, a method of coupling a valve assembly to a servo controller includes inserting a first end of a transfer tube into a cavity of a servo housing of the servo controller, the transfer tube including a bend of at least 180 degrees between the first end and a second end. The method also includes attaching the first end of the transfer tube to the servo housing, disposing the second end of the transfer tube into a cavity of a block included as part of the valve assembly, and attaching the second end of the transfer tube to the block.

### BRIEF DESCRIPTION OF THE DRAWINGS

The inventive subject matter will hereinafter be described in conjunction with the following drawing figures, wherein like numerals denote like elements, and

FIG. 1 is a partial cutaway view of an anti-ice valve component, according to an embodiment;

FIG. 2 is a cross-sectional view of a valve assembly of the anti-ice valve component shown in FIG. 1, according to an embodiment;

FIG. 3 is a simplified schematic of a servo controller connected to a valve assembly of the anti-ice valve component, according to an embodiment;

FIG. 4 is a cross-sectional view of a portion of an anti-ice valve component including transfer tubes, according to an embodiment;

FIG. 5 is a flow diagram of a method of manufacturing an anti-ice valve component, according to an embodiment;

FIG. 6 is a flow diagram of a method of manufacturing an anti-ice valve component, according to another embodiment; and

FIG. 7 is a flow diagram of a method of manufacturing an anti-ice valve component, according to still another embodiment.

### DETAILED DESCRIPTION

The following detailed description is merely exemplary in nature and is not intended to limit the inventive subject matter or the application and uses of the inventive subject matter. Furthermore, there is no intention to be bound by any theory presented in the preceding background or the following detailed description.

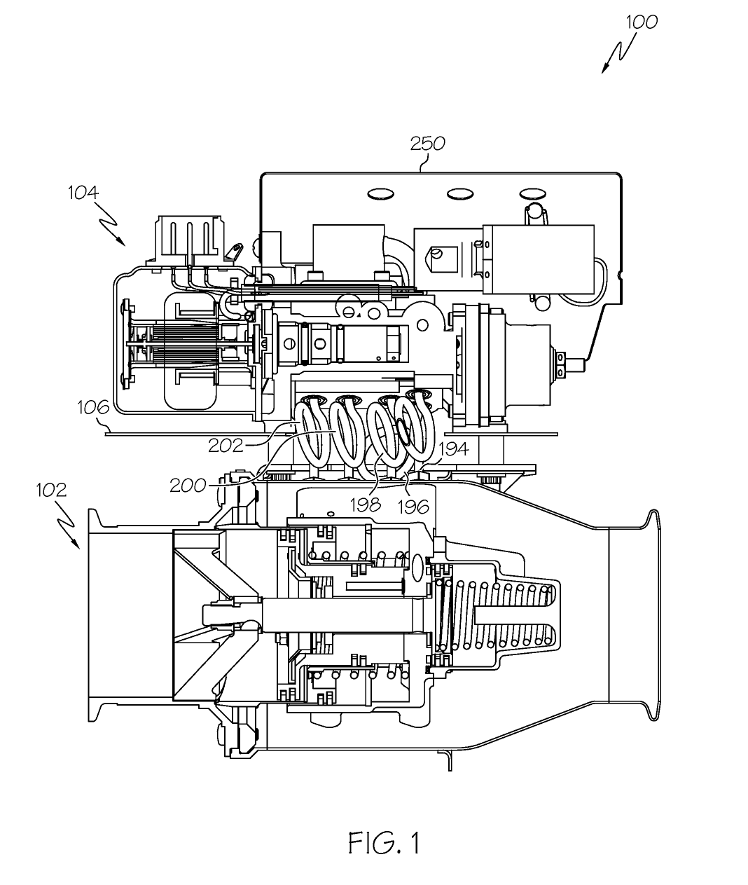

FIG. 1 is a partial cutaway view of an anti-ice valve component 100, according to an embodiment. The component 100 may be used in an aircraft de-icing system that directs bleed air from a compressor (not shown) to portions of an aircraft for use in a de-icing process. In an embodiment, the component 100 may be configured to ensure that a suitable amount of the bleed air is supplied to the de-icing system and that the supplied bleed air is suitably pressurized. In this regard, the component 100 includes a valve assembly or actuator 102 and a servo controller 104. In an embodiment, the valve assembly 102 and the servo controller 104 are spaced a predetermined distance apart from each other, and in some embodiments, may be separated from each other by a barrier 106, which may be a heat shield, a fire wall, or other type of isolation device.

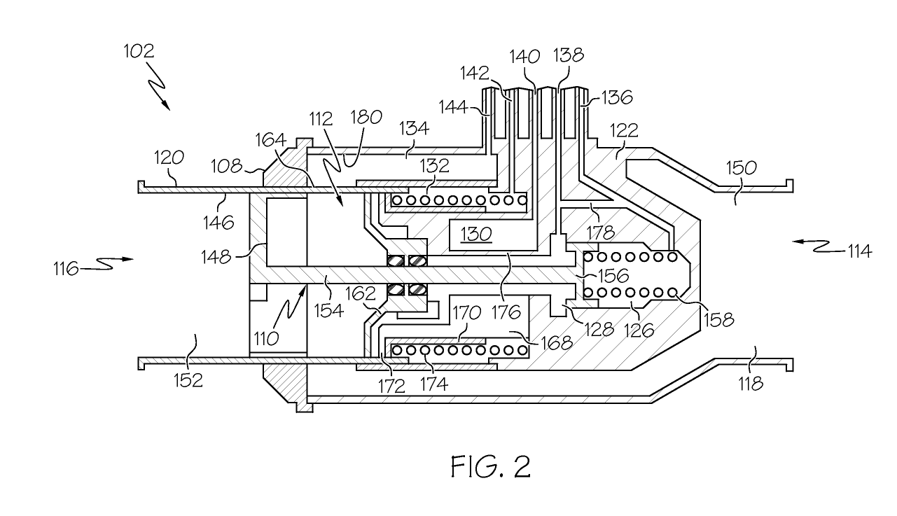

The valve assembly 102 is configured to receive the high temperature, pressurized bleed air from the compressor (not shown) before it is used for the de-icing process. FIG. 2 is a cross-sectional view of a valve assembly of the anti-ice valve component shown in FIG. 1, according to an embodiment. In an embodiment, the valve assembly or actuator 102 includes a valve housing 108, a primary valve 110, and a secondary valve 112. The valve housing 108 includes an inlet 114, an outlet 116, and a primary flowpath 118 therebetween, and the primary valve 110 and secondary valve 112 are disposed in the primary flowpath 118. In an embodiment, a valve body 120 extends at least partially through the valve housing 108 to make up a portion of each of the primary and secondary valves 110, 112. The valve body 120 may include a block 122 within which a plurality of passages 136, 138, 140, 142, 144 are formed. In an embodiment, a portion of the block 122 may be coupled to or formed as part of the valve housing 108. In another embodiment, the valve housing 108 may have an opening that provides access to the block 122. The plurality of passages 136, 138, 140, 142, 144 may communicate with a plurality of chambers 126, 128, 130, 132, 134 formed by the valve body 120, the block 122, the valve housing 108, the primary valve 110, and the secondary valve 112. Although five chambers and five passages are depicted herein, fewer or more may alternatively be employed.

The primary valve 110 includes a valve element 148 that seats an inner surface 146 of the valve body 120. The valve element 148 divides the primary flowpath 118 into an upstream portion 150 and a downstream portion 152 and is configured to axially slide through the valve body 120. In an embodiment, the valve element 148 may be coupled, via a shaft 154, that is actuated by a force created by air pressure and a spring 158 acting on a primary piston 156. The primary piston 156 and spring 158 may be disposed in a first chamber 126 formed in the block 122. The first chamber 126 communicates with a first passage 136 that is also formed in the block 122.

The secondary valve 112 may include a valve flange 162 that is configured to slide axially through the valve body 120 and one or more openings 164 through which the shaft 154 extends. The valve flange 162 may restrict passage of bleed air through the valve assembly 102 by sliding over an aperture 160 formed in the valve body 120 that opens or closes the second valve 112. The valve flange 162 is coupled to a support structure 168 having an outer surface 170 that is in slidable contact with a second piston 172, which may actuate in response to air pressure and a spring 174. The support structure 168 also includes an inner surface 176 that defines a second chamber 128 with the valve body 120 and the first piston 156. The second chamber 128 communicates with a second passage 138, which may also communicate with the first passage 136 via an axial channel 178.

A third chamber 130 may be formed in the support structure 168, and may be configured to communicate with a third passage 140 in the block 122. The outer surface 170 of the support structure 168 and the inner surface 146 of the valve body 120 may define a fourth chamber 132, which may communicate with a fourth passage 142 formed in the block 122. A fifth chamber 134 may be defined between the outer surface of the valve body 120 and an inner surface 180 of the valve housing 108 and may communicate with a fifth passage 144 formed in the block 122.

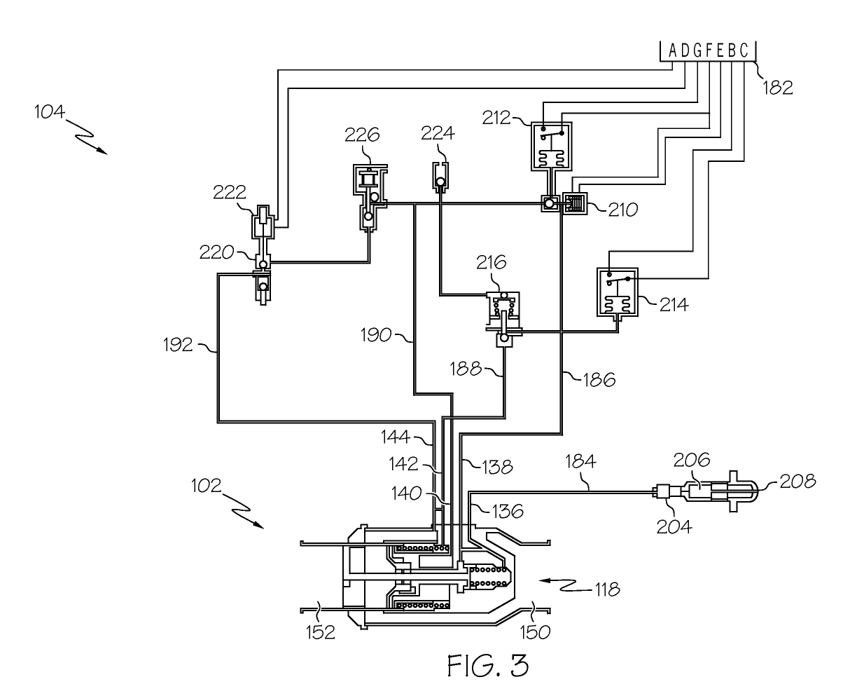

FIG. 3 is a simplified schematic of the servo controller 104 connected to the valve assembly 102, according to an embodiment. The servo controller 104 may operate pneumatically and may control the pressure of the bleed air from the passages 136, 138, 140, 142, 144 of the valve assembly 104 by comparing the pressures with acceptable predetermined threshold pressures to determine a differential, in an embodiment. Based on the differential, the servo controller 104 allows or restricts passage of the air between the upstream and downstream portions 150, 152 of the primary flowpath 118. In another embodiment, the servo controller 104 may additionally be configured to receive electrical command signals from a remote device, which may be provided to override actions by the servo controller 104 as a result of certain circumstances. For example, a user, such as a pilot, may input an override command to the remote device to shut off the servo controller 104, if anti-icing or de-icing is no longer needed.

The comparison of bleed air pressures may be performed via a plurality of solenoids, valves, and switches that are disposed along one or more lines 184, 186, 188, 190, 192. The lines 184, 186, 188, 190, 192 may be flexible or inflexible tubular structures, such as pipes, that may be used for air delivery. Referring also to FIG. 1, the solenoids, valves, switches, and lines 184, 186, 188, 190, 192 are housed within a servo housing 250. In an embodiment, the lines 184, 186, 188, 190, 192 communicate with the passages 136, 138, 140, 142, 144 via transfer tubes 194, 196, 198, 200, 202 to receive the bleed air therefrom. With continued reference to FIG. 3, in an embodiment, a first line 184 receives bleed air from the first passage 136 and includes an end that terminates at a pilot regulator 204. The pilot regulator 204 may be used to adjust a pressure within the primary valve 120 of the valve assembly 102 and may include a temperature compensator 206. In an embodiment, the pilot regulator 204 may include an ambient vent 208 to allow a portion of the bleed air to be exhausted from the first line 184.

A second line 186 may receive bleed air from the second passage 138 and may communicate with a direct current (DC) solenoid 210 that is coupled to an overpressure switch 212. The DC solenoid 210 is configured to open or close the second line 186, in response to a pressure differential between the received bleed air and a first predetermined threshold. The DC solenoid 210 also may be electrically coupled to a main controller 182, which may deliver commands from a user to override actions of the DC solenoid 210. The over pressure switch 212 may provide a signal to the main controller 182 indicating that the pressure is higher than a second predetermined threshold. In another embodiment, the second line 186 also directs bleed air to a low pressure switch 214 that is electrically coupled to the main controller 182. The low pressure switch 214 is configured to provide a signal to the main controller 182 if a pressure of the received bleed air is less than a third predetermined threshold. The second line 186 may also feed bleed air to a pneumatic switcher 216.

A third line 190 receives bleed air from the fifth passage 144, a solenoid switcher 220, and a reference pressure regulator 226. This pressure is ported to the third chamber 130 to thereby actuate the primary piston 110.

The fourth line 188 receives pressure from the second passage 138 and the second line 186 through the pneumatic switcher 216. The pneumatic switcher 216 may be set to a fourth predetermined threshold and thus, may open or close to thereby allow the bleed air to flow to the fourth line 188 depending on a differential between the fourth predetermined threshold and the pressure of the received bleed air. The pneumatic switcher 216 switches automatically from primary regulation to secondary regulation in an event that the pressure regulator 226 fails to open or the DC solenoid 210 is actuated.

In an embodiment, the fifth line 192 provides pressure via the fifth passage 144 and may provide air to a balanced pressure valve 220 that is electrically coupled to an alternating current (AC) solenoid 222. The balanced pressure valve 220 is actuated open and closed with an electric signal from the main controller 182. When actuated, the balanced pressure valve 220 opens to allow the bleed air to flow to the fifth line 192. In an embodiment, if the pressure in the fifth line 192 is above a fifth predetermined threshold, bleed air may be exhausted out a relief valve 224. In an embodiment, a reference pressure regulator 226 may be included upstream of the balanced pressure valve 220 to control the pressure of the bleed air in the fourth line 190 to a predetermined value.

It will be appreciated that one or more of the first, second, third, fourth, and fifth predetermined thresholds may or may not be equal to each other. Additionally, one or more of the thresholds may or may not be more or less than another one of the thresholds. Moreover, specific values for each threshold may depend on pressure values at which the bleed air may be suitable applied to the aircraft de-icing system.

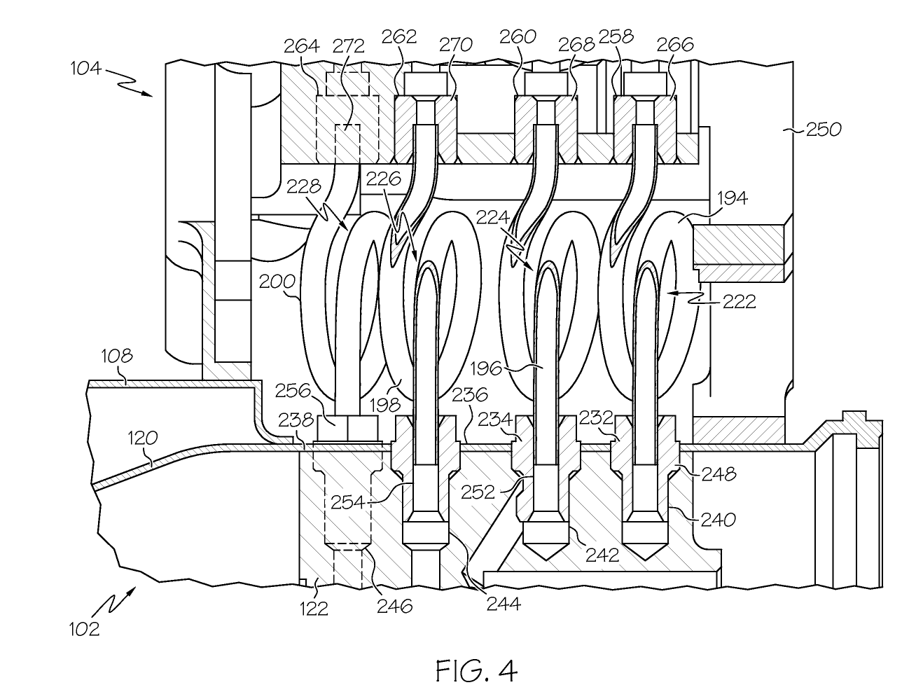

As mentioned above, the bleed air flowing between the valve assembly 102 and the servo controller 104 may be relatively high in temperature. Thus, to ensure the bleed air does not leak when traveling therebetween, the transfer tubes 194, 196, 198, 200, 202 may be configured to withstand repeated exposure to the high temperatures (e.g., temperatures greater than 538° C. (approximately 1000° F.)). FIG. 4 is a cross-sectional view of a portion of the anti-ice valve component 100 (FIG. 1) including the transfer tubes 194, 196, 198, 200, according to an embodiment. Although only four transfer tubes 194, 196, 198, 200 are shown in here, it will be understood that a fifth transfer tube is not shown but is included. In an embodiment, the material may be a high-strength, high-temperature resistant and corrosion resistant nickel-chromium alloy. For example, the material may be Inconel® 718 available from Specialty Metals Corporation of New Hartford, N.Y.

In addition to being capable of withstanding high temperatures, the transfer tubes 194, 196, 198, 200 are configured to compensate for distance fluctuation that may occur between the valve housing 108 and the servo housing 250, due to thermal expansion caused by the high temperature bleed air flowing therethrough. In an embodiment, the transfer tubes 194, 196, 198, 200 are relatively thin-walled (e.g., between about 0.25 mm and about 1.3 mm in thickness) having a diameter that may be between about 1 mm and about 25 mm. The transfer tubes 194, 196, 198, 200 may each include a portion forming a bend 222, 224, 226, 228 of at least 180 degrees. In an embodiment, the bend 222, 224, 226, 228 may be about 360 degrees. Each bend 222, 224, 226, 228 may form a portion of a substantially circular, ovular, or elliptical shape that may have a radius that is substantially equal to or greater than 1.5 times a diameter of a corresponding transfer tube 194, 196, 198, 200.

To ensure that the bleed air does not leak out of the valve assembly 102 or the servo controller 104 via the transfer tubes 194, 196, 198, 200, the tubes 194, 196, 198, 200 may be fixedly attached therebetween. In an embodiment, the valve housing 108 may include at least one opening 232, 234, 236, 238 that provides access to the valve body 120, and in particular, the block 122. As depicted in FIG. 4, the block 122 includes cavities 240, 242, 244, 246 (shown in phantom) that communicate with corresponding passages (e.g., 136, 138, 140, 142 (see FIG. 2)). An end of each transfer tube 194, 196, 198, 200 is inserted into a corresponding cavity 240, 242, 244, 246. In an embodiment, the ends are brazed to the surfaces of the block 122 defining the cavities 240, 242, 244, 246. In another embodiment, the cavities 240, 242, 244, 246 may be relatively large and brazing the ends therein may be impractical and/or expensive. In such case, adapters 248, 252, 254, 256 may be disposed in the cavities 240, 242, 244, 246 or otherwise attached. Each adapter 248, 252, 254, 256 may be configured to correspond to the shape of a corresponding cavity 240, 242, 244, 246 and may be ring-shaped. In an embodiment, one or more of the cavities 240 may have a threaded surface, and one or more of the adapters 248 may have a corresponding threaded outer surface. The adapters 248, 252, 254, 256 may be made of a material that is substantially similar to that of the transfer tubes 194, 196, 198, 200, and thus, in an embodiment, may be a nickel-chromium alloy, such as Inconel® 718. The adapters 248, 252, 254, 256 may be brazed or otherwise attached to the valve housing 108 and an end of each transfer tube 194, 196, 198, 200 may be inserted therethrough. In an embodiment, the ends of each transfer tube 194, 196, 198, 200 may be brazed to the adapters 248, 252, 254, 256. Because the adapters 248, 252, 254, 256 may also be exposed to the high temperatures of the bleed air, they may be made from materials that are similar to those of the transfer tubes 194, 196, 198, 200.

The servo housing 250 may also include a plurality of cavities 258, 260, 262, 264. The other end of each transfer tube 194, 196, 198, 200 is inserted into corresponding cavities 258, 260, 262, 264. To fix the transfer tubes 194, 196, 198, 200 to the servo housing 250, the tubes 194, 196, 198, 200 may be brazed or otherwise attached to surfaces defining the cavities 258, 260, 262, 264. In another embodiment, adapters 266, 268, 270, 272 (shown in phantom) may be included in the cavities 250, 260, 262, 264. The adapters 266, 268, 270, 272 may be ring-shaped, and the ends of the transfer tubes 194, 196, 198, 200 may be inserted therethrough. The adapters 266, 268, 270, 272 may be made of a material that is substantially similar to that of the transfer tubes 194, 196, 198, 200, and thus, in an embodiment, may be a nickel-chromium alloy, such as Inconel® 718. In still another embodiment, the ends of the transfer tubes 194, 196, 198, 200 may be brazed or otherwise attached to the adapters 266, 268, 270, 272, and the adapters 266, 268, 270, 272 may be brazed or otherwise attached to the servo housing 250.

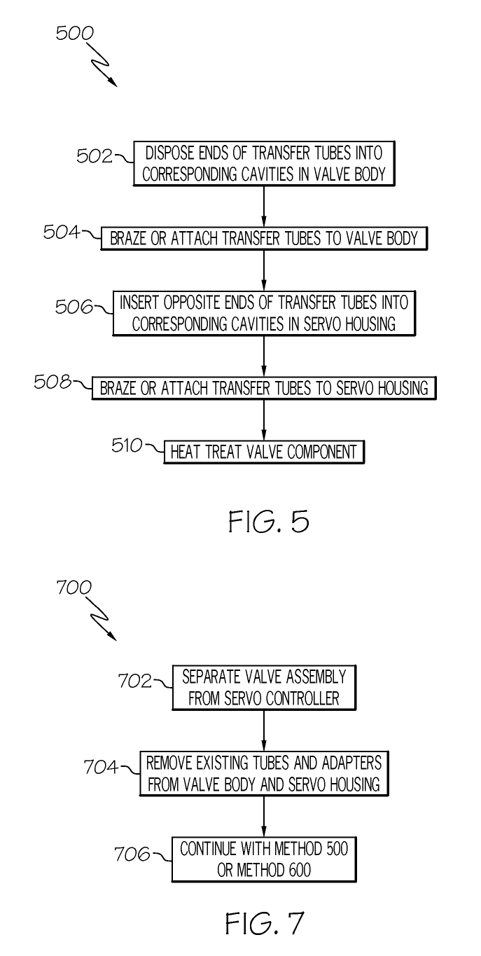

The transfer tubes 194, 196, 198, 200 may be relatively easily incorporated into anti-ice components. A flow diagram of a method 500 of manufacturing the anti-ice valve component 100 is provided in FIG. 5, according to an embodiment. In an embodiment, an end of each transfer tube 194, 196, 198, 200 is disposed in a corresponding cavity 240, 242, 244, 245 of block 122 of the valve body 120, step 502. The transfer tubes 194, 196, 198, 200 may be made of a nickel-chromium alloy and may be inserted into the cavities 240, 242, 244, 245 while in an annealed state. In this way, the tubes 194, 196, 198, 200 may be relatively flexible and easy to conform to a desired shape. The bends of each tube 194, 196, 198, 200 may be formed during this step, or alternatively may be formed prior to this step. The ends of the tubes 194, 196, 198, 200 are then brazed into or otherwise attached to the block 122 of the valve body 120, step 504. Any suitable braze material for brazing nickel-chromium alloys to a component, such as for example a gold-nickel alloy, may be used. Opposite ends of the tubes 194, 196, 198, 200 are then inserted into the cavities 258, 260, 262, 264 of the servo housing 250, step 506. The opposite ends are then brazed to or otherwise attached to the servo housing 250, step 508. To increase the structural integrity of the transfer tubes 194, 196, 198, 200, the anti-ice valve component 100 may be heat treated at an appropriate temperature, step 510. It will be appreciated that a heat treatment temperature may depend on the particular material used for the manufacture of the transfer tubes 194, 196, 198, 200.

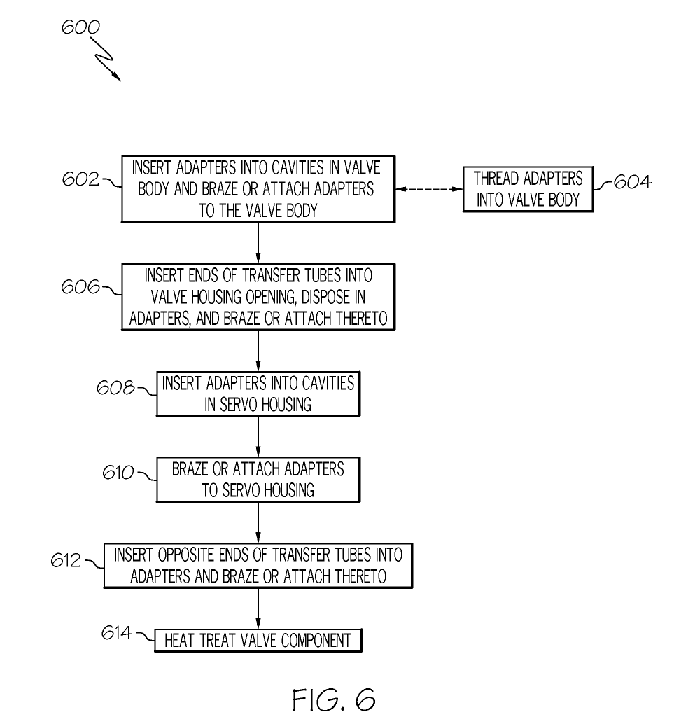

In another embodiment, if one or more of the cavities of either the valve body block 122 or the servo housing 250 is sized such that a diameter of a corresponding tube 194, 196, 198, 200 has an optimum capillary joint size for brazing (0.05 mm to 0.2 mm), one or more adapters may be included in the cavities. A flow diagram of a method 600 of manufacturing anti-ice valve components 100 including adapters is provided in FIG. 6. In an embodiment, appropriately shaped adapters 248, 252, 254, 256 are inserted into the valve body block cavities 240, 242, 244, 246 and brazed or otherwise attached to the block 122, step 602. The adapters 248, 252, 254, 256 may comprise a nickel-chromium alloy similar or a material that is similar to that of the transfer tubes 194, 196, 198, 200. Any suitable braze material for brazing nickel-chromium alloys to a component, such as for example gold-nickel alloy, may be used. In another embodiment, the adapters 248, 252, 254, 256 and the surface defining the block cavities 240, 242, 244, 246 may be threaded, thus the adapters 248, 252, 254, 256 may be threaded into the cavities 240, 242, 244, 246 before being brazed, step 604. An end of each transfer tube 194, 196, 198, 200 is then inserted through an opening 123 of the valve housing 108, disposed in a corresponding adapter 248, 252, 254, 256, and brazed or otherwise attached thereto, step 606. In an embodiment, the transfer tubes 194, 196, 198, 200 may be made of a nickel-chromium alloy. In such case, the transfer tubes 194, 196, 198, 200 may be inserted into the adapters 248, 252, 254, 256 while in an annealed state. In this way, the tubes 194, 196, 198, 200 may be relatively flexible and may be easily shaped. Bends of the transfer tubes 194, 196, 198, 200 may be formed during or prior to this step.

Next, appropriately shaped adapters 266, 268, 270, 272 may be inserted into the servo housing cavities 258, 260, 262, 264, step 608. The adapters 266, 268, 270, 272 may comprise a nickel-chromium alloy similar or a material that is similar to that of the transfer tubes 194, 196, 198, 200. The adapters 266, 268, 270, 272 may be brazed or otherwise attached to the servo housing 250, step 610. Then, opposite ends of the tubes 194, 196, 198, 200 are then inserted into the adapters 266, 268, 270, 272 and brazed or otherwise attached thereto, step 612. To increase the structural integrity of the transfer tubes 194, 196, 198, 200, the anti-ice valve component 100 may be heat treated at an appropriate temperature, step 614. It will be appreciated that a heat treatment temperature may depend on the particular material used for the manufacture of the transfer tubes 194, 196, 198, 200.

In still another embodiment, the transfer tubes 194, 196, 198, 200 may be retrofitted into an existing anti-ice valve component. A flow diagram for a method 700 of retrofitting transfer tubes 194, 196, 198, 200 into an existing anti-ice valve component is depicted in FIG. 7, according to an embodiment. The valve assembly 102 may be separated from the servo controller 104, step 702. The existing tubes and adapters, if any, are removed from the block 122 and the servo housing 250, step 704. Then, either method 500 or method 600 may be employed to incorporate the transfer tubes 194, 196, 198, 200 into the component 100, step 706.

Anti-ice valve components have now been provided that may operate by flowing bleed air therethrough having temperatures (e.g., at least 538° C. (approximately 1000° F.)). The incorporation of transfer tubes with bends therein allows the servo housing and the valve housing to expand and contract to thereby fluctuate in distance therebetween without causing wear to the component or fatigue in the transfer tubes. Additionally, brazing the ends of the transfer tubes to the valve assembly and to the servo controller may reduce the likelihood of a leak that may occur therebetween. Thus, the valve assembly and servo controller may be made of two different stainless steel formulations, while the transfer tubes may made of a nickel-based alloy. In addition, the anti-ice valve component may remain relatively lightweight and may have a similar or smaller footprint than existing components.

While at least one exemplary embodiment has been presented in the foregoing detailed description of the inventive subject matter, it should be appreciated that a vast number of variations exist. It should also be appreciated that the exemplary embodiment or exemplary embodiments are only examples, and are not intended to limit the scope, applicability, or configuration of the inventive subject matter in any way. Rather, the foregoing detailed description will provide those skilled in the art with a convenient road map for implementing an exemplary embodiment of the inventive subject matter. It being understood that various changes may be made in the function and arrangement of elements described in an exemplary embodiment without departing from the scope of the inventive subject matter as set forth in the appended claims.

What is claimed is:

1. An anti-ice valve component, comprising:
a servo housing including a surface having a cavity formed therein;
a valve body spaced apart from the servo housing and including a surface having a cavity formed therein; and
a transfer tube having a first end, a second end, and a length, the first end disposed in the servo housing cavity, the second end disposed in the valve body cavity, and the length extending between the first end and the second end and having a portion forming a bend of at least 180 degrees.

2. The anti-ice valve component of claim 1, wherein the transfer tube has a diameter and the bend has a radius that is substantially equal to or greater than 1.5 times the transfer tube diameter.

3. The anti-ice valve component of claim 1, wherein the transfer tube comprises a nickel-chromium alloy.

4. The anti-ice valve component of claim 1, wherein:
the first end of the transfer tube is brazed to the servo housing; and
the second end of the transfer tube is brazed to the valve housing.

5. The anti-ice valve component of claim 1, further comprising:
a first ring-shaped adapter disposed in the servo housing cavity, wherein the first end of the transfer tube is disposed in the first ring-shaped adapter.

6. The anti-ice valve component of claim 5, wherein:
the first end of the transfer tube is brazed to the first ring-shaped adapter, and the first ring-shaped adapter is brazed to the servo housing.

7. The anti-ice valve component of claim 1, further comprising:
a second ring-shaped adapter disposed in the valve body cavity, wherein the second end of the transfer tube is disposed in the second-ring-shaped adapter.

8. The anti-ice valve component of claim 7, wherein:
the second end of the transfer tube is brazed to the second ring-shaped adapter; and
the second ring-shaped adapter is brazed to the valve body.

9. The anti-ice valve component of claim 7, wherein:
a portion of the valve body surface defining the valve body cavity includes threading; and
the second ring-shaped adapter is threaded into the valve body cavity.

10. The anti-ice valve component of claim 1, wherein:
the transfer tube comprises a nickel-chromium alloy capable of withstanding temperatures of at least 538° C.

11. An anti-ice valve component, comprising:
a servo housing comprising a first material and including a surface having a cavity formed therein;
a valve housing spaced apart from the servo housing and comprising a second material that is different than the first material, the valve housing including a surface having a cavity formed therein; and
a transfer tube having a first end, a second end, and a length, the first end disposed in the servo housing cavity, the second end disposed in the valve body cavity, and the length extending between the first end and the second end and having a portion forming a bend of at least 180 degrees.
a first ring-shaped adapter disposed in the servo housing cavity, wherein the first end of the transfer tube is disposed in the first ring-shaped adapter; and
a second ring-shaped adapter disposed in the valve body cavity, wherein the second end of the transfer tube is disposed in the second-ring-shaped adapter.

12. The anti-ice valve component of claim 11, wherein:
the transfer tube has a diameter; and
the bend has a radius that is substantially equal to or greater than 1.5 times the transfer tube diameter.

13. The anti-ice valve component of claim 11, wherein the transfer tube comprises a nickel-based superalloy.

14. The anti-ice valve component of claim 11, wherein:
the first end of the transfer tube is brazed to the first ring-shaped adapter; and
the first ring-shaped adapter is brazed to the servo housing.

15. The anti-ice valve component of claim 11, wherein:
the second end of the transfer tube is brazed to the second ring-shaped adapter; and
the second ring-shaped adapter is brazed to the valve body.

16. The anti-ice valve component of claim 11, wherein:
a portion of the valve body surface defining the valve body cavity includes threading; and
the second ring-shaped adapter is threaded into the valve body cavity.

17. The anti-ice valve component of claim 11, wherein:
the first material comprises a first stainless steel formulation;
the second material comprises a second stainless steel formulation; and
the transfer tube comprises a nickel-based alloy capable of withstanding temperatures of at least 538° C.

18. A method of coupling a valve assembly to a servo controller, the method comprising the steps of:
inserting a first end of a transfer tube into a cavity of a servo housing of the servo controller, the transfer tube including a bend of at least 180 degrees between the first end and a second end;
attaching the first end of the transfer tube to the servo housing;
disposing the second end of the transfer tube into a cavity of a block included as part of the valve assembly; and
attaching the second end of the transfer tube to the block.

19. The method of claim 18, further comprising attaching a first ring-shaped adapter disposed in the servo housing cavity to the servo housing and attaching the first end of the transfer tube to the first ring-shaped adapter.

20. The method of claim 18, further comprising attaching a second ring-shaped adapter disposed in the block cavity to the block and attaching the first end of the transfer tube to the second ring-shaped adapter.
